(19) United States
(12) Patent Application Publication
(10) Pub. No.: US 2010/0240816 A1
(43) Pub. Date: Sep. 23, 2010

(54) EPOXY RESIN COMPOSITION CONTAINING ISOCYANURATES FOR USE IN ELECTRICAL LAMINATES

(75) Inventors: Zeng Kun Liao, Lake Jackson, TX (US); Michael J. Mullins, Houston, TX (US); Robert L. Hearn, Lake Jackson, TX (US); Ernesto Occhiello, Houston, TX (US); Joseph Gan, Strasbourg (FR)

Correspondence Address: The Dow Chemical Company;Osha Liang LLP, Two Houston Center, 909 Fannin Street, Suite 3500, Houston, TX, 77010-2002, US

(73) Assignee: DOW GLOBAL TECHNOLOGIES INC., Midland, MI (US)

(21) Appl. No.: 12/739,223

(22) PCT Filed: Oct. 24, 2008
(86) PCT No.: PCT/US08/81106

§ 371 Date: Apr. 22, 2010

Related U.S. Application Data
(60) Provisional application No. 60/982,996, filed on Oct. 26, 2007.

(51) Int. Cl. C08K 5/05; C08G 18/00; C08L 75/00

(52) U.S. Cl. 524/384; 528/59; 525/452

(57) ABSTRACT

A resin composition comprising oligomers having a molar ratio of isocyanurate to oxazolidinone greater than 1:1, wherein the weight average molecular weight of the oligomers is less than or equal to 3000, as measured by gel permeation chromatography. Such resin compositions may be combined with a hardener to form a curable composition. Also disclosed is a process for forming a resin composition, including: reacting diisocyanates to form isocyanurates; reacting isocyanate groups in the isocyanurates and unreacted diisocyanates with an epoxy precursor to form a resin composition comprising oligomers having: a molar ratio of isocyanurate to oxazolidinone greater than 1:1; wherein the weight average molecular weight of the oligomers is less than or equal to 3000, as measured by gel permeation chromatography. Such compositions may be useful in prepregs and laminates.

### BACKGROUND OF DISCLOSURE

1. Field of the Disclosure

Embodiments disclosed herein relate generally to isocyanurate-epoxy formulations. More specifically, embodiments disclosed herein relate to isocyanurate-epoxy formulations having high glass transition temperatures and high decomposition temperatures.

2. Background

Resins used in electrical laminate applications often require a good balance of properties. For example, a resin having a low viscosity may reduce problems with voids, poor fiber wetting, poor prepreg appearance, and other issues. Resins having a high glass transition temperature are also desirable.

With the advent of lead-free solders for printed circuit boards, the requirements for dimensional stability of the circuit boards have increased, especially due to the higher melting point of the typical lead-free solders. A particular problem encountered when producing circuit boards with lead-free solders is the thermal expansion of the circuit board in the z-axis (perpendicular to the normal plane). Above the glass transition temperature of the resin, z-axis expansion can cause fracture of the plated-through-copper vias that connect circuit layers. Resins with high glass transition temperatures are therefore in increasing demand. Brominated resins can be used for lead-free solder applications. However, the brominated resins are typically at their limit of thermal stability.

Brominated resins, including oligomers that contain epoxides and oxazolidones or oxazolidinones, have been used commercially for some time. For example, U.S. Pat. No. 5,112,932 describes a process for preparing solutions of oxazolidone oligomers terminated with epoxy groups. EP 478606 describes a process for the preparation of solutions of isocyanurate/oxazolidinone oligomers in which the oxazolidinone groups predominate.

Similarly, WO 1990/015089 describes polyoxazolidones prepared by a process in which various process parameters are controlled in a manner to result in a product having from 50 to 100 percent of the isocyanate groups converted to oxazolidone rings and from 0 to 50 percent of the isocyanate groups converted to isocyanurate rings. These epoxy terminated polyoxazolidones exhibit high glass transition temperatures and high resistance to chemicals when cured. Also disclosed is their use in the preparation of electrical laminates and electrical circuit boards. Similarly, Kinjo et al. describe general methods for preparing mixed isocyanurate/oxazolidone oligomers in Kinjo et al., Journal of Applied Polymer Science, 28, 5, pages 1729-1741 (1983) and Kinjo et al., Polymer Journal, 14, 6, pages 505-507 (1982).

U.S. Pat. No. 4,070,416 (Hitachi Ltd.) describes a process for producing thermosetting resins by mixing one equivalent or more of polyfunctional isocyanate per equivalent of a polyfunctional epoxide in the presence of a tertiary amine, morpholine derivatives or imidazole catalysts. The resulting resins are described as having excellent electrical and mechanical properties and high thermal stability. The resins are also described as useful in various applications such as heat resistance insulation varnishes, casting resins, impregnation resins, molding resins for electrical parts, adhesives, resins for laminating boards, and resins for printed circuits.

Oligomers, such as those described above, prepared by reacting epoxy monomers with isocyanates, contain oxazolidinones. The presence of oxazolidinones allows for a relatively high glass transition temperature, but has the disadvantage of a lower decomposition temperature for the cured resin.

Accordingly, there exists a need for improvements in the glass transition and decomposition temperatures of brominated resins, as well as methods to manufacture these resins. In particular, it is desired for these resins to have a combination of viscosity, molecular weight, and gellation properties that are within an acceptable or desirable range in addition to improved decomposition and glass transition temperatures.

### SUMMARY OF THE DISCLOSURE

In one aspect, embodiments disclosed herein relate to resin compositions including oligomers having a molar ratio of isocyanurate to oxazolidinone greater than 1:1, wherein the weight average molecular weight of the oligomers is less than or equal to 3000, as measured by gel permeation chromatography.

In another aspect, embodiments disclosed herein relate to a process for forming a resin composition, including: reacting diisocyanates to form isocyanurates; reacting isocyanate groups in the isocyanurates and unreacted diisocyanates with an epoxy precursor to form a resin composition comprising oligomers having: a molar ratio of isocyanurate to oxazolidinone greater than 1:1; wherein the weight average molecular weight of the oligomers is less than or equal to 3000, as measured by gel permeation chromatography.

Other aspects and advantages will be apparent from the following description and the appended claims.

### DETAILED DESCRIPTION

In one aspect, embodiments disclosed herein relate to resin compositions formed from isocyanate and epoxy compounds. More specifically, embodiments disclosed herein relate to resin compositions formed by trimerizing a diisocyanate to form an isocyanurate, and subsequently reacting the resulting composition with epoxy compounds to form oxazolidinone compounds, where the resulting resin composition has a ratio of oxazolidinone to isocyanurate of less than 1:1.

It has been found that the trimerization of isocyanates to isocyanurates may improve the glass transition temperature (T_{g}) of the resin. Additionally, isocyanurates have less of a tendency to reduce the decomposition temperature (T_{d}) of the resulting resin. Unfortunately, this trimerization reaction is difficult to control, and may lead to high molecular weight resins and gellation. The viscosity of the resin can therefore be prohibitively high, which can be extremely detrimental for many applications. It is possible to lower the solution viscosity by adding a solvent, lowering the resin concentration. However, the addition of solvent is generally undesirable, as the solvent must be removed during preparation of the finished composite.

The present inventors have found that, by carefully controlling the process conditions under which the isocyanurate is trimerized and the subsequent epoxide condensation is conducted, molecular weight, viscosity, and gellation of the resulting mixture may be controlled to be within acceptable ranges. Additionally, the resulting resins may exhibit improved T_{g}'s when cured while maintaining a high T_{d}. This combination of properties is especially advantageous for electrical laminates.

Throughout this disclosure, gel permeation chromatography analysis was performed with an Agilent 1100 GPC with a Agilent model G1316A Refractive Index detector. It contained a PLgel 5 μm guard column (50 mm×7.5 mm) and two PLgel 5 μm Mixed D columns (300 mm×7.5 mm). The solvent used was tetrahydrofuran (uninhibited HPLC grade) and the flow rate was 1 ml/min. The column temperature was 30° C. and the detector temperature was 35° C. The injector volume was 100 μl and the run time was 30 minutes. The standard used was Polymers Labs EasiCal PS-2 (polystyrene 580-400000 peak molecular weight). A 0.05 gram sample was dissolved in 10 ml of tetrahydrofuran (THF) and 10 drops of 1 wt. % sulfur in THF was added to the sample as a flow marker. The sample was filtered using a 0.45 μm syringe filter. Valley to valley manual peak detection was used with conventional quantitation by retention time relative to flow marker vs standard peak molecular weight.

For example, resin compositions described herein may have a low viscosity, such as less than 10 poise at 150° C. (as measured with an ICI Cone and Plate Viscometer with a #4 spindle at 150° C.), and a ratio of oxazolidinone to isocyanurate of less than 1:1. In some embodiments, the resin compositions described herein may have a viscosity of less than 10 poise, as measured using an ICI Cone and Plate Viscometer with a #4 spindle at 150° C. In other embodiments, the resin compositions may have a viscosity of less than 9 poise as measured at 150° C. using a cone and plate viscometer; less than 8 poise in other embodiments; less than 7 poise in other embodiments; and less than 6 poise in yet other embodiments. Carefully controlling process conditions, as described herein, such as the catalyst, monomer concentration, and reaction time, among other variables, during the formation of the isocyanurate may keep the molecular weight and polydispersity low while achieving adequate conversion of the isocyanate.

Low molecular weight is easy to achieve when the conversion is low. Conversion of less than 50% of the isocyanates leads to a molar ratio (isocyanate/isocyanurate) of greater than 3. However, treatment of such an isocyanate/isocyanurate precursor with an epoxy monomer leads to an undesirably high concentration of oxazolidinone, leading to relatively low thermal stability.

The present inventors have discovered that resins, including brominated resins, with improved decomposition temperatures can be prepared if more than 50% of the isocyanate groups are allowed to trimerize (oligomerize) to isocyanurate oligomers, after which the pendant isocyanates are reacted with an epoxide to form the isocyanurate resin, as shown below:

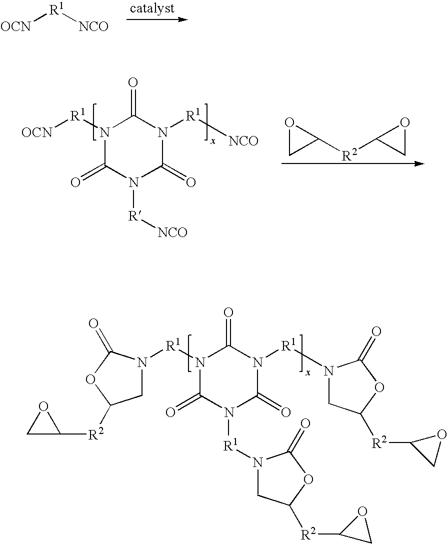

where the symbols ‘R¹’ and ‘R²’ represent aromatic or aliphatic diradicals, and x is intended to represent the number average degree of polymerization. In other words, the oligomers are a distribution of molecular weights. In some embodiments, the number average degree of polymerization is at least 2.5; at least 2.75 in other embodiments; at least 2.9 in other embodiments; at least 3 in other embodiments; at least 3.1 in other embodiments; and at least 3.25 in yet other embodiments. Preferably, the number average degree of polymerization x is less than 4 (i.e., primarily trimers).

Although the oligomers are shown above as being substantially linear, branching may occur. However, this branching should be controlled such that the oligomers have a polydispersity (M_{w}/Mₙ) of less than 2. At polydispersities greater than 2, the viscosity typically becomes too high for a given level of isocyanurate. Thus, in some embodiments of the compositions disclosed herein, the oligomers may have a polydispersity of less than 2; less than 1.9 in other embodiments; less than 1.8 in other embodiments; less than 1.7 in other embodiments; less than 1.6 in other embodiments; and less than 1.5 in yet other embodiments.

Polydispersity is a measure of the molecular weight uniformity of a polymer. It is the ratio of Mw/Mn (weight average molecular weight/number average molecular weight). The number average molecular weight is simply the weight of the sample divided by the number of molecules. The weight average molecular weight is more complicated: it is the sum of the weight fractions times the weight percentage of each fraction (see Chap. 10 of the “Encyclopedia of Polymer Science and Technology” John Wiley and Sons). For a polymer composed of chains with equal lengths, the Mₙ and M_{w} are identical, and therefore the polydispersity is equal to one. In the present application, lower polydispersities are desirable. This is because the M_{w} correlates with solution viscosity, and low viscosities are desirable. These molecular weight data are generally measured using gel permeation chromatography. The above reference contains a general description (Chap. 10 of the “Encyclopedia of Polymer Science and Technology” John Wiley and Sons).

In addition to the diisocyanate to be trimerized, small amounts of a monofunctional isocyanate (e.g., R³—NCO, where R³ represents an aliphatic or aromatic radical such as C₆H₅—, MeC₆H₄—, EtC₆H₄—, Et₂C₆H₃—, methyl, i-propyl, i-butyl, and Ph(Me)CH—, among others) may optionally be added with the diisocyanate (OCN—R¹—NCO) to improve (lower) the polydispersity and lower the M_{w} for a given conversion. Small amounts of isocyanate with functionality greater than 2 may also be present, but may makes it more difficult to maintain sufficiently low M_{w}.

In preparing the oligomers described herein, typically more than 50% of the isocyanates are reacted to form isocyanurate oligomers. In some embodiments, at least 52.5% of the isocyanates are reacted to form isocyanurate oligomers; at least 55% in other embodiments; at least 57.5% in other embodiments; at least 60% in yet other embodiments.

The resin compositions described herein contain oligomers that have a molar ratio of isocyanurate to oxazolidinone that is greater than 1:1. In some embodiments, the oligomers may have a molar ratio of isocyanurate to oxazolidinone that is greater than 1.5:1; greater than 2:1 in other embodiments; greater than 2.5:1 in other embodiments; greater than 3:1 in other embodiments; greater than 3.5:1 in other embodiments; greater than 4:1 in other embodiments; greater than 4.5:1 in other embodiments; and greater than 5:1 in yet other embodiments.

The weight average molecular weight, M_{w}, of the oligomers is typically less than 3,000, as measured by gel permeation chromatography. For example, in some embodiments the M_{w} is less than 2900, as measured by GPC; less than 2750 in other embodiments; and less than 2500 in yet other embodiments. The M_{w} is an important variable to control, allowing the oligomer solutions to have low viscosity with a minimum of solvent or no solvent.

The oligomers described herein may be prepared by adding a diisocyanate to a solution of an epoxide and a catalyst. The diisocyanate may be added at a selected feed rate, either in portions or in a slow continuous fashion (i.e., added continuously or intermittently), at a low temperature, typically less than 150° C. Under these conditions, it is possible to selectively trimerize the isocyanate, without substantial formation of oxazolidinone, while avoiding formation of high M_{w} oligomers, which increase viscosity. The trimerization is exothermic, thus it is important to maintain adequate cooling so as to maintain the solution at conditions to selectively trimerize the diisocyanate. After at least 50% of the diisocyanate is consumed, the temperature may be raised (typically above 140° C.) to cause the formation of oxazolidinone, consuming the unreacted isocyanate groups in the isocyanurates and any non-oligomerized isocyanates. In some embodiments, more than 95% of the isocyanate groups are reacted; more than 96% in other embodiments; more than 97% in other embodiments; more than 98% in other embodiments; more than 99% in other embodiments. In some embodiments, the isocyanate groups are completely consumed (100% reacted).

The process used to make the resin compositions disclosed herein, in general, involves two steps. In the first step, oligomers are formed as described above: diisocyanate is added at a selected feed rate to an epoxide in the presence of a catalyst under conditions where the rate of the isocyanurate formation is much faster than formation of oxazolidinone. The mixture, during addition of the diisocyanate, may be maintained at a temperature between 100 to 150° C. In other embodiments, the mixture may be maintained at a temperature between 100° C. and 140° C. during addition of the isocyanate; between 110° C. and 140° C. in other embodiments; between 120° C. and 140° C. in other embodiments; and between 125° C. and 135° C. in yet other embodiments.

It is also important to add diisocyanate at a rate that is slower than the conversion rate of the diisocyanates to isocyanurates, preferably maintaining the concentration of isocyanate in the mixture low (such as below 0.5 M) at all times. This is important to achieving the high isocyanurate to oxazolidinone ratios desired. In some embodiments, the concentration of isocyanate starting material (expressed as moles starting NCO/L) is from 0.01 to 1.0; between 0.05 to 0.5 in other embodiments; and from 0.1 to 0.5 in other embodiments; and from 0.1 to 0.4 in yet other embodiments. The optimal rate of diisocyanate addition may depend on the catalyst, catalyst concentration, and reaction temperature, among other variables.

The second step of the process is the reaction of the epoxide to convert the residual isocyanate groups to oxazolidinones. As mentioned above, it is usually desirable to convert a high percentage (>95 mol %) of the isocyanate groups to optimize properties and minimize the concentration of residual starting isocyanate groups. Additionally, a problem that should be avoided during this step is conversion of the isocyanurate rings to oxazolidinones, as describe by Kinjo, et al (Journal of Apply Polymer Science Vol. 28, No 5, 1729-1741 (1983). (N. Kinjo Polymer Journal 1982, No. 14, 505-7). This problem may be avoided by stopping the reaction when a significant portion or all of the isocyanate groups have been converted to either oxazolidinones or isocyanurates. A suitable temperature for the reaction of epoxides and residual isocyanate groups is between 140° C. and 175° C.; between 140° C. and 170° C. in other embodiments; and between 150° C. and 160° C. in yet other embodiments.

The primary use of the resulting resin compositions is as matrix materials for electrical laminates. For this purpose it is necessary to form a curable composition by combining the resin compositions with a hardener. The resulting curable composition may then be cured to form a thermoset composition.

The oligomers described herein may also be used in formulations that contain brominated and non-brominated flame retardants. Other embodiments of the resins and oligomers may be used for encapsulation or potting of electronics, matrix resins for composites, and for powder coatings and liquid coatings for use in high-temperatures applications.

The curable compositions described herein, comprising of a mixture of the oligomeric resin composition and at least one of a hardener and a flame retardant, may have a gel time at 171° C. of less than 10 minutes. Gel time was determined by a stroke cure method on a 171° C. hot plate based on IPC Method IPC-TM-650 2.3.18. The curable compositions may have a gel time at 170° C. of less than 9 minutes in other embodiments; less than 8 minutes in other embodiments; less than 7 minutes in other embodiments; less than 6 minutes in other embodiments; less than 5 minutes in other embodiments; and less than 4 minutes in yet other embodiments; greater than 1 minute in other embodiments; greater than 3 minutes in other embodiments; greater than 5 minutes in other embodiments; and greater than 7 minutes in yet other embodiments.

The thermoset compositions (cured) may have a glass transition temperature, as measured by differential scanning calorimetry (DSC) (IPC Method IPC-TM-650 2.4.25), of at least 155° C. In other various embodiments, the thermoset compositions may have a glass transition temperature of at least 156° C., 157° C., 158° C., 159° C., 160° C., 161° C., 162° C., 163° C., 164° C., 165° C., or 170° C.

The thermoset compositions (cured) may have a degradation temperature, T_{d}, at 5% weight loss, of at least 305° C. Thermal decomposition was measured according to IPC Method IPC-TM-650 2.4.24.6, using a thermo-gravimetric analyzer (TGA) ramped to 800° C. at 5° C./minute under a nitrogen atmosphere. The T_{d} measurement is the temperature at which 5 weight percent of the sample is lost to decomposition products. In other various embodiments, the thermoset compositions may have a degradation temperature of at least 306° C., 307° C., 308° C., 309° C., 310° C., 311° C., 312° C., 313° C., 314° C., 315° C., or 320° C.

As described above, embodiments disclosed herein include various components, such as isocyanates (mono-, di-, or poly-functional), epoxy resins, catalysts, hardeners, flame retardant additives (brominated and non-brominated), and substrates. Examples of each of these components are described in more detail below.

Isocyanate

Isocyanates useful in embodiments disclosed herein may include isocyanates, polyisocyanates, and isocyanate prepolymers. Suitable polyisocyanates include any of the known aliphatic, alicyclic, cycloaliphatic, araliphatic, and aromatic di- and/or polyisocyanates.

Aliphatic polyisocyanates may include hexamethylene diisocyanate, trimethylhexamethylene diisocyanate, dimeric acid diisocyanate, lysine diisocyanate and the like. Alicyclic diisocyanates may include isophorone diisocyanate, 4,4′-methylenebis(cyclohexylisocyanate), methylcyclohexane-2,4- or -2,6-diisocyanate, 1,3- or 1,4-di(isocyanatomethyl)cyclohexane, 1,4-cyclohexane diisocyanate, 1,3-cyclopentane diisocyanate, 1,2-cyclohexane diisocyanate, and the like. Aromatic diisocyanate compounds may include xylylene diisocyanate, metaxylylene diisocyanate, tetramethylxylylene diisocyanate, tolylene diisocyanate, 4,4′-diphenylmethane diisocyanate, 1,5-naphthalene diisocyanate, 1,4-naphthalene diisocyanate, 4,4′-toluidine diisocyanate, 4,4′-diphenyl ether diisocyanate, m- or p-phenylene diisocyanate, 4,4′-biphenylene diisocyanate, 3,3′-dimethyl-4,4′-biphenylene diisocyanate, bis(4-isocyanatophenyl)-sulfone, isopropylidenebis (4-phenylisocyanate), and the like. Polyisocyanates having three or more isocyanate groups per molecule may include, for example, triphenylmethane-4,4′,4″-triisocyanate, 1,3,5-triisocyanato-benzene, 2,4,6-triisocyanatotoluene, 4,4′-dimethyldiphenylmethane-2,2′,5,5′-tetraisocyanate, and the like.

Other isocyanate compounds may include tetramethylene diisocyanate, toluene diisocyanate, hydrogenated diphenylmethane diisocyanate, hydrogenated xylylene diisocyanate, and trimers of these isocyanate compounds; terminal isocyanate group-containing compounds obtained by reacting the above isocyanate compound in an excess amount and a low molecular weight active hydrogen compounds (e.g., ethylene glycol, propylene glycol, trimethylolpropane, glycerol, sorbitol, ethylenediamine, monoethanolamine, diethanolamine, triethanolamine etc.) or high molecular weight active hydrogen compounds such as polyesterpolyols, polyetherpolyols, polyamides and the like may be used in embodiments disclosed herein.

Other useful polyisocyanates include, but are not limited to oligomers of methylene diisocyanate, oligomers of toluene diisocyanate, 1,2-ethylenediisocyanate, 2,2,4- and 2,4,4-trimethyl-1,6-hexamethylenediisocyanate, 1,12-dodecandiisocyanate, omega, omega-diisocyanatodipropylether, cyclobutan-1,3-diisocyanate, cyclohexan-1,3- and 1,4-diisocyanate, 2,4- and 2,6-diisocyanato-1-methylcylcohexane, 3-isocyanatomethyl-3,5,5-trimethyl cyclohexylisocyanate (“isophoronediisocyanate”), 2,5- and 3,5-bis-(isocyanatomethyl)-8-methyl-1,4-methano, decahydronaphthathalin, 1,5-, 2,5-, 1,6- and 2,6-bis-(isocyanatomethyl)-4,7-methanohexahydroindan, 1,5-, 2,5-, 1,6- and 2,6-bis-(isocyanato)-4,7-methanohexahydroindan, dicyclohexyl-2,4′- and -4,4′-diisocyanate, omega, omega-diisocyanato-1,4-diethylbenzene, 1,3- and 1,4-phenylenediisocyanate, 4,4′-diisocyanatodiphenyl, 4,4′-diisocyanato-3,3′-dichlorodiphenyl, 4,4′-diisocyanato-3,3′-methoxy-diphenyl, 4,4′-diisocyanato-3,3′-diphenyl-diphenyl, naphthalene-1,5-diisocyanate, N—N′-(4,4′-dimethyl-3,3′-diisocyanatodiphenyl)-uretdione, 2,4,4′-triisocyanatano-diphenylether, 4,4′,4″-triisocyanatotriphenylmethane, and tris(4-isocyanatophenyl)-thiophosphate.

Other suitable polyisocyanates may include: 1,8-octamethylenediisocyanate; 1,11-undecane-methylenediisocyanate; 1,12-dodecamethylendiisocyanate; 1-isocyanato-3-isocyanatomethyl-3,5,5-trimethylcyclohexane; 1-isocyanato-1-methyl-4(3)-isocyanatomethylcyclohexane; 1-isocyanato-2-isocyanatomethylcyclopentane; (4,4′- and/or 2,4′-) diisocyanato-dicyclohexylmethane; bis-(4-isocyanato-3-methylcyclohexyl)-methane; a,a,a′,a′-tetramethyl-1,3- and/or -1,4-xylylenediisocyanate; 1,3- and/or 1,4-hexahydroxylylene-diisocyanate; 2,4- and/or 2,6-hexahydrotoluene-diisocyanate; 2,4- and/or 2,6-toluene-diisocyanate; 4,4′- and/or 2,4′-diphenylmethane-diisocyanate; n-isopropenyl-dimethylbenzyl-isocyanate; any double bond containing isocyanate; and any of their derivatives having urethane-, isocyanurate-, allophanate-, biuret-, uretdione-, and/or iminooxadiazindione groups.

Polyisocyanates may also include aliphatic compounds such as trimethylene, pentamethylene, 1,2-propylene, 1,2-butylene, 2,3-butylene, 1,3-butylene, ethylidene and butylidene diisocyanates, and substituted aromatic compounds such as dianisidine diisocyanate, 4,4′-diphenylether diisocyanate and chlorodiphenylene diisocyanate.

Other isocyanate compounds are described in, for example, U.S. Pat. Nos. 6,288,176, 5,559,064, 4,637,956, 4,870,141, 4,767,829, 5,108,458, 4,976,833, and 7,157,527, U.S. Patent Application Publication Nos. 20050187314, 20070023288, 20070009750, 20060281854, 20060148391, 20060122357, 20040236021, 20020028932, 20030194635, and 20030004282, each of which is hereby incorporated by reference. Isocyanates formed from polycarbamates are described in, for example, U.S. Pat. No. 5,453,536, hereby incorporated by reference herein. Carbonate isocyanates are described in, for example, U.S. Pat. No. 4,746,754, hereby incorporated by reference herein.

In some embodiments, suitable isocyanate precursors may include methane diisocyanate, butane-1,1-diisocyanate, ethane-1,2-diisocyanate, butanediisocyanate, transvinylene diisocyanate, propane-1,3-diisocyanate, 2-butene-1,4-diisocyanate, 2-methylbutane-1,4-diisocyanate, hexane-1,6-diisocyanate, octane-1,8-diisocyanate, diphenylsilanediisocyanate, benzene-1,3-bis(methyleneisocyanate), benzene-1,4-bis(methyleneisocyanate), isophorone diisocyanate, cyclohexane-1,3-bis(methyleneisocyanate), isomers of toluene diisocyanate, isomers of xylenediisocyanate, methylene bis(4-benzeneisocyanate) benzene (or MDI), bis(4-benzeneisocyanate) ether, bis(4-benzeneisocyanate) sulfide, and bis(4-benzeneisocyanate) sulfone.

Various isocyanates that may be useful in embodiments disclosed herein are commercially available, such as those available from The Dow Chemical Company under the trademarks ISONATE, VORANATE, VORATEC, and VORACOR, among others.

Mixtures of any of the above-listed isocyanates may, of course, also be used.

Epoxy Resins

The epoxy resins used in embodiments disclosed herein may vary and include conventional and commercially available epoxy resins, which may be used alone or in combinations of two or more, including, for example, novolac resins, isocyanate modified epoxy resins, and carboxylate adducts, among others. In choosing epoxy resins for compositions disclosed herein, consideration should not only be given to properties of the final product, but also to viscosity and other properties that may influence the processing of the resin composition.

The epoxy resin component may be any type of epoxy resin useful in molding compositions, including any material containing one or more reactive oxirane groups, referred to herein as “epoxy groups” or “epoxy functionality.” Epoxy resins useful in embodiments disclosed herein may include mono-functional epoxy resins, multi- or poly-functional epoxy resins, and combinations thereof. Monomeric and polymeric epoxy resins may be aliphatic, cycloaliphatic, aromatic, or heterocyclic epoxy resins. The polymeric epoxies include linear polymers having terminal epoxy groups (a diglycidyl ether of a polyoxyalkylene glycol, for example), polymer skeletal oxirane units (polybutadiene polyepoxide, for example) and polymers having pendant epoxy groups (such as a glycidyl methacrylate polymer or copolymer, for example). The epoxies may be pure compounds, but are generally mixtures or compounds containing one, two or more epoxy groups per molecule. In some embodiments, epoxy resins may also include reactive —OH groups, which may react at higher temperatures with anhydrides, organic acids, amino resins, phenolic resins, or with epoxy groups (when catalyzed) to result in additional crosslinking.

In general, the epoxy resins may be glycidated resins, cycloaliphatic resins, epoxidized oils, and so forth. The glycidated resins are frequently the reaction product of a glycidyl ether, such as epichlorohydrin, and a bisphenol compound such as bisphenol A; C₄ to C₂₈ alkyl glycidyl ethers; C₂ to C₂₈ alkyl- and alkenyl-glycidyl esters; C₁ to C₂₈ alkyl-, mono- and poly-phenol glycidyl ethers; polyglycidyl ethers of polyvalent phenols, such as pyrocatechol, resorcinol, hydroquinone, 4,4′-dihydroxydiphenyl methane (or bisphenol F), 4,4′-dihydroxy-3,3′-dimethyldiphenyl methane, 4,4′-dihydroxydiphenyl dimethyl methane (or bisphenol A), 4,4′-dihydroxydiphenyl methyl methane, 4,4′-dihydroxydiphenyl cyclohexane, 4,4′-dihydroxy-3,3′-dimethyldiphenyl propane, 4,4′-dihydroxydiphenyl sulfone, and tris(4-hydroxyphenyl)methane; polyglycidyl ethers of the chlorination and bromination products of the above-mentioned diphenols; polyglycidyl ethers of novolacs; polyglycidyl ethers of diphenols obtained by esterifying ethers of diphenols obtained by esterifying salts of an aromatic hydrocarboxylic acid with a dihaloalkane or dihalogen dialkyl ether; polyglycidyl ethers of polyphenols obtained by condensing phenols and long-chain halogen paraffins containing at least two halogen atoms. Other examples of epoxy resins useful in embodiments disclosed herein include bis-4,4′-(1-methylethylidene) phenol diglycidyl ether and (chloromethyl) oxirane bisphenol A diglycidyl ether.

In some embodiments, the epoxy resin may include glycidyl ether type; glycidyl-ester type; alicyclic type; heterocyclic type, and halogenated epoxy resins, etc. Non-limiting examples of suitable epoxy resins may include cresol novolac epoxy resin, phenolic novolac epoxy resin, biphenol epoxy resin, hydroquinone epoxy resin, stilbenediol epoxy resin, and mixtures and combinations thereof.

Suitable polyepoxy compounds may include resorcinol diglycidyl ether (1,3-bis-(2,3-epoxypropoxy)benzene), diglycidyl ether of bisphenol A (2,2-bis(p-(2,3-epoxypropoxy)phenyl)propane), triglycidyl p-aminophenol (4-(2,3-epoxypropoxy)-N,N-bis(2,3-epoxypropyl)aniline), diglycidyl ether of bromobisphenol A (2,2-bis(4-(2,3-epoxypropoxy)-3-bromo-phenyl)propane), diglycidylether of bisphenol F (2,2-bis(p-(2,3-epoxypropoxy)phenyl)methane), triglycidyl ether of meta- and/or para-aminophenol (3-(2,3-epoxypropoxy)N,N-bis(2,3-epoxypropyl)aniline), and tetraglycidyl methylene dianiline (N,N,N′,N′-tetra(2,3-epoxypropyl) 4,4′-diaminodiphenyl methane), and mixtures of two or more polyepoxy compounds. A more exhaustive list of useful epoxy resins found may be found in Lee, H. and Neville, K., Handbook of Epoxy Resins, McGraw-Hill Book Company, 1982 reissue.

Other suitable epoxy resins include polyepoxy compounds based on aromatic amines and epichlorohydrin, such as N,N′-diglycidyl-aniline; N,N′-dimethyl-N,N′-diglycidyl-4,4′-diaminodiphenyl methane; N,N,N,N′-tetraglycidyl-4,4′-diaminodiphenyl methane; N-diglycidyl-4-aminophenyl glycidyl ether; and N,N,N′,N′-tetraglycidyl-1,3-propylene bis-4-aminobenzoate. Epoxy resins may also include glycidyl derivatives of one or more of: aromatic diamines, aromatic monoprimary amines, aminophenols, polyhydric phenols, polyhydric alcohols, polycarboxylic acids.

Useful epoxy resins include, for example, polyglycidyl ethers of polyhydric polyols, such as ethylene glycol, triethylene glycol, 1,2-propylene glycol, 1,5-pentanediol, 1,2,6-hexanetriol, glycerol, and 2,2-bis(4-hydroxy cyclohexyl)propane; polyglycidyl ethers of aliphatic and aromatic polycarboxylic acids, such as, for example, oxalic acid, succinic acid, glutaric acid, terephthalic acid, 2,6-napthalene dicarboxylic acid, and dimerized linoleic acid; polyglycidyl ethers of polyphenols, such as, for example, bis-phenol A, bis-phenol F, 1,1-bis(4-hydroxyphenyl)ethane, 1,1-bis(4-hydroxyphenyl)isobutane, and 1,5-dihydroxy napthalene; modified epoxy resins with acrylate or urethane moieties; glycidlyamine epoxy resins; and novolac resins.

The epoxy compounds may be cycloaliphatic or alicyclic epoxides. Examples of cycloaliphatic epoxides include diepoxides of cycloaliphatic esters of dicarboxylic acids such as bis(3,4-epoxycyclohexylmethyl)oxalate, bis(3,4-epoxycyclohexylmethyl)adipate, bis(3,4-epoxy-6-methylcyclohexylmethyl) adipate, bis(3,4-epoxycyclohexylmethyl) pimelate; vinylcyclohexene diepoxide; limonene diepoxide; dicyclopentadiene diepoxide; and the like. Other suitable diepoxides of cycloaliphatic esters of dicarboxylic acids are described, for example, in U.S. Pat. No. 2,750,395.

Other cycloaliphatic epoxides include 3,4-epoxycyclohexylmethyl-3,4-epoxycyclohexane carboxylates such as 3,4-epoxycyclohexylmethyl-3,4-epoxycyclohexane carboxylate; 3,4-epoxy-1-methylcyclohexyl-methyl-3,4-epoxy-1-methylcyclohexane carboxylate; 6-methyl-3,4-epoxycyclohexylmethylmethyl-6-methyl-3,4-epoxycyclohexane carboxylate; 3,4-epoxy-2-methylcyclohexylmethyl-3,4-epoxy-2-methylcyclohexane carboxylate; 3,4-epoxy-3-methylcyclohexyl-methyl-3,4-epoxy-3-methylcyclohexane carboxylate; 3,4-epoxy-5-methylcyclohexyl-methyl-3,4-epoxy-5-methylcyclohexane carboxylate and the like. Other suitable 3,4-epoxycyclohexylmethyl-3,4-epoxycyclohexane carboxylates are described, for example, in U.S. Pat. No. 2,890,194.

Further epoxy-containing materials which are particularly useful include those based on glycidyl ether monomers. Examples are di- or polyglycidyl ethers of polyhydric phenols obtained by reacting a polyhydric phenol with an excess of chlorohydrin such as epichlorohydrin. Such polyhydric phenols include resorcinol, bis(4-hydroxyphenyl)methane (known as bisphenol F), 2,2-bis(4-hydroxyphenyl) propane (known as bisphenol A), 2,2-bis(4′-hydroxy-3′,5′-dibromophenyl) propane, 1,1,2,2-tetrakis(4′-hydroxy-phenyl)ethane or condensates of phenols with formaldehyde that are obtained under acid conditions such as phenol novolacs and cresol novolacs. Examples of this type of epoxy resin are described in U.S. Pat. No. 3,018,262. Other examples include di- or polyglycidyl ethers of polyhydric alcohols such as 1,4-butanediol, or polyalkylene glycols such as polypropylene glycol and di- or polyglycidyl ethers of cycloaliphatic polyols such as 2,2-bis(4-hydroxycyclohexyl)propane. Other examples are monofunctional resins such as cresyl glycidyl ether or butyl glycidyl ether.

Another class of epoxy compounds are polyglycidyl esters and poly(beta-methylglycidyl) esters of polyvalent carboxylic acids such as phthalic acid, terephthalic acid, tetrahydrophthalic acid or hexahydrophthalic acid. A further class of epoxy compounds are N-glycidyl derivatives of amines, amides and heterocyclic nitrogen bases such as N,N-diglycidyl aniline, N,N-diglycidyl toluidine, N,N,N′,N′-tetraglycidyl bis(4-aminophenyl)methane, triglycidyl isocyanurate, N,N′-diglycidyl ethyl urea, N,N′-diglycidyl-5,5-dimethylhydantoin, and N,N′-diglycidyl-5-isopropylhydantoin.

Still other epoxy-containing materials are copolymers of acrylic acid esters of glycidol such as glycidylacrylate and glycidylmethacrylate with one or more copolymerizable vinyl compounds. Examples of such copolymers are 1:1 styrene-glycidylmethacrylate, 1:1 methyl-methacrylateglycidylacrylate and a 62.5:24:13.5 methylmethacrylate-ethyl acrylate-glycidylmethacrylate.

Epoxy compounds that are readily available include octadecylene oxide; glycidylmethacrylate; diglycidyl ether of bisphenol A; D.E.R. 331 (bisphenol A liquid epoxy resin) and D.E.R. 332 (diglycidyl ether of bisphenol A) available from The Dow Chemical Company, Midland, Mich.; vinylcyclohexene dioxide; 3,4-epoxycyclohexylmethyl-3,4-epoxycyclohexane carboxylate; 3,4-epoxy-6-methylcyclohexyl-methyl-3,4-epoxy-6-methylcyclohexane carboxylate; bis(3,4-epoxy-6-methylcyclohexylmethyl) adipate; bis(2,3-epoxycyclopentyl)ether; aliphatic epoxy modified with polypropylene glycol; dipentene dioxide; epoxidized polybutadiene; silicone resin containing epoxy functionality; flame retardant epoxy resins (such as a brominated bisphenol type epoxy resin available under the tradename D.E.R. 580, available from The Dow Chemical Company, Midland, Mich.); 1,4-butanediol diglycidyl ether of phenolformaldehyde novolac (such as those available under the tradenames D.E.N. 431 and D.E.N. 438 available from The Dow Chemical Company, Midland, Mich.); and resorcinol diglycidyl ether Although not specifically mentioned, other epoxy resins under the tradename designations D.E.R. and D.E.N. available from the Dow Chemical Company may also be used.

Epoxy resins may also include isocyanate modified epoxy resins. Polyepoxide polymers or copolymers with isocyanate or polyisocyanate functionality may include epoxy-polyurethane copolymers. These materials may be formed by the use of a polyepoxide prepolymer having one or more oxirane rings to give a 1,2-epoxy functionality and also having open oxirane rings, which are useful as the hydroxyl groups for the dihydroxyl-containing compounds for reaction with diisocyanate or polyisocyanates. The isocyanate moiety opens the oxirane ring and the reaction continues as an isocyanate reaction with a primary or secondary hydroxyl group. There is sufficient epoxide functionality on the polyepoxide resin to enable the production of an epoxy polyurethane copolymer still having effective oxirane rings. Linear polymers may be produced through reactions of diepoxides and diisocyanates. The di- or polyisocyanates may be aromatic or aliphatic in some embodiments.

Other suitable epoxy resins are disclosed in, for example, U.S. Pat. Nos. 7,163,973, 6,632,893, 6,242,083, 7,037,958, 6,572,971, 6,153,719, and 5,405,688 and U.S. Patent Application Publication Nos. 20060293172 and 20050171237, each of which is hereby incorporated herein by reference.

Examples of suitable epoxy resins and epoxy precursors that may be used in some embodiments described herein include: diglycidyl ethers of diols such as bisphenol A, bisphenol F, bisphenol K (4,4′-dihydroxybenzophenone), bisphenol S (4,4′-dihydroxyphenyl sulfone), hydroquinone, resorcinol, 1,1-cyclohexanebisphenol, ethylene glycol, propylene glycol, diethylene glycol, dipropylene glycol, butanediol, hexanediol, cyclohexanediol, 1,4-bis(hydroxymethyl)benzene, 1,3-bis(hydroxymethyl)benzene, 1,4-bis(hydroxymethyl)cyclohexane, 1,3-bis(hydroxymethyl)cyclohexane; diepoxy compounds such as: cyclooctene diepoxide, divinylbenzene diepoxide, 1,7-octadiene, 1,3-butadiene, 1,5-hexadiene, 4-cyclohexenecarboxylate cyclohexenemethanol ester; and glycidyl ether derivatives of novolacs such as phenol novolac, cresol novolak, and bisphenol A novolak.

Catalysts

Catalysts may include imidazole compounds including compounds having one imidazole ring per molecule, such as imidazole, 2-methylimidazole, 2-ethyl-4-methylimidazole, 2-undecylimidazole, 2-heptadecylimidazole, 2-phenylimidazole, 2-phenyl-4-methylimidazole, 1-benzyl-2-methylimidazole, 2-ethylimidazole, 2-isopropylimidazole, 2-phenyl-4-benzylimidazole, 1-cyanoethyl-2-methylimidazole, 1-cyanoethyl-2-ethyl-4-methylimidazole, 1-cyanoethyl-2-undecylimidazole, 1-cyanoethyl-2-isopropylimidazole, 1-cyanoethyl-2-phenylimidazole, 2,4-diamino-6-[2′-methylimidazolyl-(1)′]-ethyl-s-triazine, 2,4-diamino-6-[2′-ethyl-4-methylimidazolyl-(1)′]-ethyl-s-triazine, 2,4-diamino-6-[2′-undecylimidazolyl-(1)′]-ethyl-s-triazine, 2-methyl-imidazo-lium-isocyanuric acid adduct, 2-phenylimidazolium-isocyanuric acid adduct, 1-aminoethyl-2-methylimidazole, 2-phenyl-4,5-dihydroxymethylimidazole, 2-phenyl-4-methyl-5-hydroxymethylimidazole, 2-phenyl-4-benzyl-5-hydroxymethylimidazole and the like; and compounds containing 2 or more imidazole rings per molecule which are obtained by dehydrating above-named hydroxymethyl-containing imidazole compounds such as 2-phenyl-4,5-dihydroxymethylimidazole, 2-phenyl-4-methyl-5-hydroxymethylimidazole and 2-phenyl-4-benzyl-5-hydroxy-methylimidazole; and condensing them with formaldehyde, e.g., 4,4′-methylene-bis-(2-ethyl-5-methylimidazole), and the like.

In other embodiments, suitable catalysts may include amine catalysts such as N-alkylmorpholines, N-alkylalkanolamines, N,N-dialkylcyclohexylamines, and alkylamines where the alkyl groups are methyl, ethyl, propyl, butyl and isomeric forms thereof, and heterocyclic amines.

Non-amine catalysts may also be used. Organometallic compounds of bismuth, lead, tin, titanium, iron, antimony, uranium, cadmium, cobalt, thorium, aluminum, mercury, zinc, nickel, cerium, molybdenum, vanadium, copper, manganese, and zirconium, may be used. Illustrative examples include bismuth nitrate, lead 2-ethylhexoate, lead benzoate, ferric chloride, antimony trichloride, stannous acetate, stannous octoate, and stannous 2-ethylhexoate. Other catalysts that may be used are disclosed in, for example, PCT Publication No. WO 00/15690, which is incorporated by reference in its entirety.

In some embodiments, suitable catalysts may include nucleophilic amines and phosphines, especially nitrogen heterocycles such as alkylated imidazoles: 2-phenyl imidazole, 2-methyl imidazole, 1-methyl imidazole, 2-methyl-4-ethyl imidazole; other heterocycles such as diazabicycloundecene (DBU), diazabicyclooctene, hexamethylenetetramine, morpholine, piperidine; trialkylamines such as triethylamine, trimethylamine, benzyldimethyl amine; phosphines such as triphenylphosphine, tritolylphosphine, triethylphosphine; quaternary salts such as triethylammonium chloride, tetraethylammonium chloride, tetraethylammonium acetate, triphenylphosphonium acetate, and triphenylphosphonium iodide.

Mixtures of one or more of the above described catalysts may also be used.

Epoxy Hardeners/Curing Agents

A hardener or curing agent may be provided for promoting crosslinking of the resin composition to foam a thermoset composition. The hardeners and curing agents may be used individually or as a mixture of two or more. In some embodiments, hardeners may include dicyandiamide (dicy) or phenolic curing agents such as novolacs, resoles, bisphenols. Other hardeners may include advanced (oligomeric) epoxy resins, some of which are disclosed above. Examples of advanced epoxy resin hardeners may include, for example, epoxy resins prepared from bisphenol A diglycidyl ether (or the diglycidyl ether of tetrabromobisphenol A) and an excess of bisphenol or (tetrabromobisphenol). Anhydrides such as poly(styrene-co-maleic anhydride) may also be used.

Curing agents may also include primary and secondary polyamines and adducts thereof, anhydrides, and polyamides. For example, polyfunctional amines may include aliphatic amine compounds such as diethylene triamine (D.E.H. 20, available from The Dow Chemical Company, Midland, Mich.), triethylene tetramine (D.E.H. 24, available from The Dow Chemical Company, Midland, Mich.), tetraethylene pentamine (D.E.H. 26, available from The Dow Chemical Company, Midland, Mich.), as well as adducts of the above amines with epoxy resins, diluents, or other amine-reactive compounds. Aromatic amines, such as metaphenylene diamine and diamine diphenyl sulfone, aliphatic polyamines, such as amino ethyl piperazine and polyethylene polyamine, and aromatic polyamines, such as metaphenylene diamine, diamino diphenyl sulfone, and diethyltoluene diamine, may also be used.

Anhydride curing agents may include, for example, nadic methyl anhydride, hexahydrophthalic anhydride, trimellitic anhydride, dodecenyl succinic anhydride, phthalic anhydride, methyl hexahydrophthalic anhydride, tetrahydrophthalic anhydride, and methyl tetrahydrophthalic anhydride, among others.

The hardener or curing agent may include a phenol-derived or substituted phenol-derived novolac or an anhydride. Non-limiting examples of suitable hardeners include phenol novolac hardener, cresol novolac hardener, dicyclopentadiene bisphenol hardener, limonene type hardener, anhydrides, and mixtures thereof.

In some embodiments, the phenol novolac hardener may contain a biphenyl or naphthyl moiety. The phenolic hydroxy groups may be attached to the biphenyl or naphthyl moiety of the compound. This type of hardener may be prepared, for example, according to the methods described in EP915118A1. For example, a hardener containing a biphenyl moiety may be prepared by reacting phenol with bismethoxy-methylene biphenyl.

In other embodiments, curing agents may include dicyandiamide, boron trifluoride monoethylamine, and diaminocyclohexane. Curing agents may also include imidazoles, their salts, and adducts. These epoxy curing agents are typically solid at room temperature. Examples of suitable imadazole curing agents are disclosed in EP906927A1. Other curing agents include aromatic amines, aliphatic amines, anhydrides, and phenols.

In some embodiments, the curing agents may be an amino compound having a molecular weight up to 500 per amino group, such as an aromatic amine or a guanidine derivative. Examples of amino curing agents include 4-chlorophenyl-N,N-dimethyl-urea and 3,4-dichlorophenyl-N,N-dimethyl-urea.

Other examples of curing agents useful in embodiments disclosed herein include: 3,3′- and 4,4′-diaminodiphenylsulfone; methylenedianiline; bis(4-amino-3,5-dimethyl-phenyl)-1,4-diisopropylbenzene available as EPON 1062 from Shell Chemical Co.; and bis(4-aminophenyl)-1,4-diisopropylbenzene available as EPON 1061 from Hexion Chemical Co.

Thiol curing agents for epoxy compounds may also be used, and are described, for example, in U.S. Pat. No. 5,374,668. As used herein, “thiol” also includes polythiol or polymercaptan curing agents. Illustrative thiols include aliphatic thiols such as methanedithiol, propanedithiol, cyclohexanedithiol, 2-mercaptoethyl-2,3-dimercapto-succinate, 2,3-dimercapto-1-propanol (2-mercapto acetate), diethylene glycol bis(2-mercaptoacetate), 1,2-dimercaptopropyl methyl ether, bis(2-mercaptoethyl)ether, trimethylolpropane tris(thioglycolate), pentaerythritol tetra(mercaptopropionate), pentaerythritol tetra(thioglycolate), ethyleneglycol dithioglycolate, trimethylolpropane tris(beta-thiopropionate), tris-mercaptan derivative of tri-glycidyl ether of propoxylated alkane, and dipentaerythritol poly(beta-thiopropionate); halogen-substituted derivatives of the aliphatic thiols; aromatic thiols such as di-, tris- or tetra-mercaptobenzene, bis-, tris- or tetra-(mercaptoalkyl)benzene, dimercaptobiphenyl, toluenedithiol and naphthalenedithiol; halogen-substituted derivatives of the aromatic thiols; heterocyclic ring-containing thiols such as amino-4,6-dithiol-sym-triazine, alkoxy-4,6-dithiol-sym-triazine, aryloxy-4,6-dithiol-sym-triazine and 1,3,5-tris (3-mercaptopropyl) isocyanurate; halogen-substituted derivatives of the heterocyclic ring-containing thiols; thiol compounds having at least two mercapto groups and containing sulfur atoms in addition to the mercapto groups such as bis-, tris- or tetra(mercaptoalkylthio)benzene, bis-, tris- or tetra(mercaptoalkylthio)alkane, bis(mercaptoalkyl) disulfide, hydroxyalkylsulfidebis(mercaptopropionate), hydroxyalkylsulfidebis (mercaptoacetate), mercaptoethyl ether bis(mercaptopropionate), 1,4-dithian-2,5-diolbis(mercaptoacetate), thiodiglycolic acid bis(mercaptoalkyl ester), thiodipropionic acid bis(2-mercaptoalkyl ester), 4,4-thiobutyric acid bis(2-mercaptoalkyl ester), 3,4-thiophenedithiol, bismuththiol and 2,5-dimercapto-1,3,4-thiadiazol.

The curing agent may also be a nucleophilic substance such as an amine, a tertiary phosphine, a quaternary ammonium salt with a nucleophilic anion, a quaternary phosphonium salt with a nucleophilic anion, an imidazole, a tertiary arsenium salt with a nucleophilic anion, and a tertiary sulfonium salt with a nucleophilic anion.

Aliphatic polyamines that are modified by adduction with epoxy resins, acrylonitrile, or methacrylates may also be utilized as curing agents. In addition, various Mannich bases can be used. Aromatic amines wherein the amine groups are directly attached to the aromatic ring may also be used.

Quaternary ammonium salts with a nucleophilic anion useful as a curing agent in embodiments disclosed herein may include tetraethyl ammonium chloride, tetrapropyl ammonium acetate, hexyl trimethyl ammonium bromide, benzyl trimethyl ammonium cyanide, cetyl triethyl ammonium azide, N,N-dimethylpyrrolidinium isocyanate, N-methylpyridinium phenolate, N-methyl-o-chloropyridinium chloride, methyl viologen dichloride and the like.

The suitability of the curing agent for use herein may be determined by reference to manufacturer specifications or routine experimentation. Manufacturer specifications may be used to determine if the curing agent is an amorphous solid or a crystalline solid at the desired temperatures for mixing with the liquid or solid epoxy. Alternatively, the solid curing agent may be tested using differential scanning calorimetry (DSC) to determine the amorphous or crystalline nature of the solid curing agent and the suitability of the curing agent for mixing with the resin composition in either liquid or solid form.

Flame Retardant Additives

As described above, the resin compositions described herein may be used in formulations that contain brominated and non-brominated flame retardants. Specific examples of brominated additives include tetrabromobisphenol A (TBBA) and materials derived therefrom: TBBA-diglycidyl ether, reaction products of bisphenol A or TBBA with TBBA-diglycidyl ether, and reaction products of bisphenol A diglycidyl ether with TBBA.

Non-brominated flame retardants include the various materials derived from DOP (9,10-dihydro-9-oxa-10-phosphaphenanthrene 10-oxide) such as DOP-hydroquinone (10-(2′,5′-dihydroxyphenyl)-9,10-dihydro-9-oxa-10-phosphaphenanthrene 10-oxide), condensation products of DOP with glycidylether derivatives of novolacs, and inorganic flame retardants such as aluminum trihydrate and aluminum phosphinite.

Optional Additives

Curable and thermoset compositions disclosed herein may optionally include conventional additives and fillers. Additives and fillers may include, for example, silica, glass, talc, metal powders, titanium dioxide, wetting agents, pigments, coloring agents, mold release agents, coupling agents, ion scavengers, UV stabilizers, flexibilizing agents, and tackifying agents. Additives and fillers may also include fumed silica, aggregates such as glass beads, polytetrafluoroethylene, polyol resins, polyester resins, phenolic resins, graphite, molybdenum disulfide, abrasive pigments, viscosity reducing agents, boron nitride, mica, nucleating agents, and stabilizers, among others. Fillers and modifiers may be preheated to drive off moisture prior to addition to the epoxy resin composition. Additionally, these optional additives may have an effect on the properties of the composition, before and/or after curing, and should be taken into account when formulating the composition and the desired reaction product.

In some embodiments, minor amounts of higher molecular weight, relatively non-volatile monoalcohols, polyols, and other epoxy- or isocyanato-reactive diluents may be used, if desired, to serve as plasticizers in the curable and thermoset compositions disclosed herein.

Curable Compositions

Curable compositions described herein may be formed by combining the resin composition, comprising oligomers having a ratio of isocyanurate to oxazolidinone greater than 1:1, with a hardener. The proportions of the resin composition and the hardener may depend, in part, upon the properties desired in the curable composition or coating to be produced, the desired cure response of the composition, and the desired storage stability of the composition (desired shelf life).

For example, in some embodiments, a curable composition may be formed by admixing a resin composition and one or more hardeners, with or without a catalyst, to form a mixture. The relative amounts of the resin composition, hardeners, and catalyst, if used, may depend upon the desired properties of the cured composition, as described above. In other embodiments, a process to form a curable composition may include one or more of the steps of forming a resin composition, as described above, admixing a hardener, admixing a flame retardant, and admixing additives.

In some embodiments, the resin composition may be present in an amount ranging from 0.1 to 99 weight percent of the curable composition. In other embodiments, the resin composition may range from 0.1 to 50 weight percent of the curable composition; from 15 to 45 weight percent in other embodiments; and from 25 to 40 weight percent in yet other embodiments. In other embodiments, the resin composition may range from 50 to 99 weight percent of the curable composition; from 60 to 95 weight percent in yet other embodiments; and from 70 to 90 weight percent in yet other embodiments.

In some embodiments, the catalyst may be present in an amount ranging from 0.01 weight percent to 10 weight percent. In other embodiments, the catalyst may be present in an amount ranging from 0.1 weight percent to 8 weight percent; from 0.5 weight percent to 6 weight percent in other embodiments; and from 1 to 4 weight percent in yet other embodiments.

In some embodiments, hardeners may also be admixed with the resin compositions described herein. Variables to consider in selecting a hardener and an amount of the hardener may include, for example, properties of the resin composition, the desired properties of the cured composition (flexibility, electrical properties, etc.), desired cure rates, as well as the number of reactive groups per hardener molecule, such as the number of active hydrogens in an amine. The amount of hardener used may vary from 0.1 to 150 parts per hundred parts resin composition, by weight, in some embodiments. In other embodiments, the hardener may be used in an amount ranging from 5 to 95 parts per hundred parts resin composition, by weight; and the hardener may be used in an amount ranging from 10 to 90 parts per hundred parts resin composition, by weight, in yet other embodiments.

Substrates

The curable compositions described above may be disposed on a substrate and cured. The substrate is not subject to particular limitation. As such, substrates may include metals, such as stainless steel, iron, steel, copper, zinc, tin, aluminium, alumite and the like; alloys of such metals, and sheets which are plated with such metals and laminated sheets of such metals. Substrates may also include polymers, glass, and various fibers, such as, for example, carbon/graphite; boron; quartz; aluminum oxide; glass such as E glass, S glass, S-2 GLASS® or C glass; and silicon carbide or silicon carbide fibers containing titanium. Commercially available fibers may include: organic fibers, such as KEVLAR from DuPont; aluminum oxide-containing fibers, such as NEXTEL fibers from 3M; silicon carbide fibers, such as NICALON from Nippon Carbon; and silicon carbide fibers containing titanium, such as TYRRANO from Ube. In particular embodiments, the curable compositions may be used to form at least a portion of a circuit board or a printed circuit board. In some embodiments, the substrate may be coated with a compatibilizer to improve the adhesion of the curable or cured composition to the substrate.

Composites and Coated Structures

In some embodiments, composites may be formed by curing the curable compositions disclosed herein. In other embodiments, composites may be formed by applying a curable composition to a substrate or a reinforcing material, such as by impregnating or coating the substrate or reinforcing material, and curing the curable composition.

The above described curable compositions may be in the form of a powder, slurry, or a liquid. After a curable composition has been produced, as described above, it may be disposed on, in, or between the above described substrates, before, during, or after cure of the curable composition.

For example, a composite may be formed by coating a substrate with a curable composition. Coating may be performed by various procedures, including spray coating, curtain flow coating, coating with a roll coater or a gravure coater, brush coating, and dipping or immersion coating.

In various embodiments, the substrate may be monolayer or multi-layer. For example, the substrate may be a composite of two alloys, a multi-layered polymeric article, and a metal-coated polymer, among others, for example. In other various embodiments, one or more layers of the curable composition may be disposed on or in a substrate. Other multi-layer composites, formed by various combinations of substrate layers and curable composition layers are also envisaged herein.

In some embodiments, the heating of the curable composition may be localized, such as to avoid overheating of a temperature-sensitive substrate, for example. In other embodiments, the heating may include heating the substrate and the curable composition.

Curing of the curable compositions disclosed herein may require a temperature of at least about 30° C., up to about 250° C., for periods of minutes up to hours, depending on the resin composition, hardener, and catalyst, if used. In other embodiments, curing may occur at a temperature of at least 100° C., for periods of minutes up to hours. Post-treatments may be used as well, such post-treatments ordinarily being at temperatures between about 100° C. and 200° C.

In some embodiments, curing may be staged to prevent exotherms. Staging, for example, includes curing for a period of time at a temperature followed by curing for a period of time at a higher temperature. Staged curing may include two or more curing stages, and may commence at temperatures below about 180° C. in some embodiments, and below about 150° C. in other embodiments.

In some embodiments, curing temperatures may range from a lower limit of 30° C., 40° C., 50° C., 60° C., 70° C., 80° C., 90° C., 100° C., 110° C., 120° C., 130° C., 140° C., 150° C., 160° C., 170° C., or 180° C. to an upper limit of 250° C., 240° C., 230° C., 220° C., 210° C., 200° C., 190° C., 180° C., 170° C., 160° C., where the range may be from any lower limit to any upper limit.

The curable compositions and composites described herein may be useful as adhesives, structural and electrical laminates, coatings, castings, structures for the aerospace industry, and as circuit boards and the like for the electronics industry, among other applications. The curable compositions disclosed herein may also be used in electrical varnishes, encapsulants, semiconductors, general molding powders, filament wound pipe, storage tanks, liners for pumps, and corrosion resistant coatings, among others.

### EXAMPLES

### Example 1

A five neck 1 liter glass reactor, equipped with a mechanical stirrer, an addition funnel, a cooling condenser, a N₂ inlet, a thermometer, and a heating mantle is assembled in a well-ventilated hood. A jet of compressed air is setup so that cooling could be applied in the event of an over-temperature or runaway condition. The reactor is charged with 170 g bisphenol-A diglycidyl ether (D.E.R.™ 383, available from The Dow Chemical Co., Midland, Mich., having an epoxy equivalent weight (EEW) of 180 g/eq, and a density of 1.20 g/cc) and 60 mg 2-phenylimidazole (catalyst). After heating to 130° C., a 10 g portion of toluene diisocyanate (TDI, having approximately an 80/20 ratio of the 2,4/2,6 isomers) is added to the reactor at 130-135° C. over a 10 minute period followed by a 10 minute holding period. A second 10 g portion of TDI is then added over 9 minutes followed by another 10 minute holding period. The last 10 g of TDI is then added over a 7 minute period, followed by a 5 minute wait. The temperature is then raised to 140-145° C. over approximately 5 minutes and held at that temperature for 30 minutes. Finally, the temperature is raised to 150-155° C. over 5 minutes and held at that temperature for 30 minutes before the reactor contents are allowed to cool.

During the cooling period, the residual isocyanate level is measured by FT-IR (due to the sharp isocyanate peak at 2275 cm⁻¹). The EEW is 244 g/eq, and the molar ratio of oxazolidinone to isocyanurate is 20/80 (as determined by FT-IR peak height at 1710 and 1750 cm⁻¹ for the isocyanurate and oxazolidinone, respectively), and the viscosity at 150° C. is 8.4 poise (as measured with a cone and plate viscometer).

A portion of this resin (4.88 g, 20 meq) is combined with D.E.R.™ 560 (a brominated solid epoxy resin (2.84 g, 6.2 meq), available from The Dow Chemical Company, Midland, Mich.), 35 mg dicyandiamide, and 55 mg 2-methylimidazole. The calculated amount of bromine in this formulation is 18 wt % on a solids basis. The gel time, glass transition and decomposition temperatures of the resulting brominated resin are then measured, the results of which are presented in Table 1.

### Example 2

The apparatus described in Example 1 is charged with 187 g bisphenol-A diglycidyl ether (D.E.R.™ 383, available from The Dow Chemical Co., having an epoxy equivalent weight (EEW) of 180 g/eq) and 66 mg 2-phenylimidazole. After heating to 130° C., a 10 g portion of toluene diisocyanate (TDI, having approximately an 80/20 ratio of the 2,4/2,6 isomers) is added to the reactor at 130-135° C. over 6 minutes followed by a 7 minute holding period. A second 10 g portion of TDI is then added over 10 minutes followed by another 8 minute holding period. The last 10 g of TDI is then added over an 8 minute period, followed by an 8 minute holding period. The temperature is then raised to 140-145° C. over 5 min and held for 30 min, and then the temperature is increased to 150-155° C. over 5 min and held for 30 min before the reactor contents are allowed to cool.

During the cooling period, the residual isocyanate level is measured by FT-IR (due to the sharp isocyanate peak at 2275 cm⁻¹). The EEW is 238 g/eq, and the molar ratio of oxazolidinone to isocyanurate is 15/85 (as determined by FT-IR peak height), and the viscosity at 150° C. is 6.0 poise (as measured with a cone and plate viscometer).

### Example 3

The apparatus described in Example 1 is charged with 170 g bisphenol-A diglycidyl ether (D.E.R.™ 383, available from The Dow Chemical Co., having an epoxy equivalent weight (EEW) of 180 g/eq) and 60 mg 2-phenylimidazole. After heating to 130° C., a 10 g portion of toluene diisocyanate (TDI, having approximately an 80/20 ratio of the 2,4/2,6 isomers) is added to the reactor at 130-135° C. over 10 minutes followed by an 11 minute holding period. The reaction is then heated to 140-145° C., and a second 10 g portion of TDI is then added over 13 minutes followed by another 9 minute holding period. The last 10 g of TDI is then added over a 10 minutes period, followed by a 5 minute holding period. The temperature is then raised to 150-155° C. over 5 min and held for 30 min before the reactor contents are allowed to cool.

During the cooling period, the residual isocyanate level is measured by FT-IR (due to the sharp isocyanate peak at 2275 cm⁻¹). The EEW is 264 g/eq, and the molar ratio of oxazolidinone to isocyanurate is 55/45 (as determined by FT-IR peak height), and the viscosity at 150° C. is 5.6 poise (measured with a cone and plate viscometer).

A portion of the resulting resin (5.28 g, 20 meq) is combined with D.E.R.™ 560 brominated solid epoxy resin (3.07 g, 6.7 meq, available from The Dow Chemical Company), 35 mg dicyandiamide, and 55 mg 2-methylimidazole. The calculated amount of bromine in this formulation is 18 wt % on a solids basis. The gel time, glass transition and decomposition temperatures of the resulting brominated resin are then measured, the results of which are presented in Table 1.

### Example 4

The apparatus described in Example 1 was charged with 170 g bisphenol-A diglycidyl ether (D.E.R.™ 383, available from The Dow Chemical Co., having an epoxy equivalent weight (EEW) 180 g/eq) and 100 mg 2-phenylimidazole. The contents of the reactor are then heated to 165-175° C. and 30 g of TDI is added over a 45 minute period. The temperature is maintained between 165-175° C. for an additional 30 minutes, and the contents are allowed to cool.

During the cooling period, the residual isocyanate level is measured by FT-IR (due to the sharp isocyanate peak at 2275 cm⁻¹). The EEW is 349 g/eq, the molar ratio of oxazolidinone to isocyanurate is 100/0 (as determined by FT-IR peak height), and the viscosity at 150° C. was 9.6 poise (as measured with a cone and plate viscometer).

A portion of this resin (7.08 g, 20 meq) was combined with D.E.R.™ 560 brominated solid epoxy resin (4.11 g, 9 meq, available from The Dow Chemical Company), 35 mg dicyandiamide, and 55 mg 2-methylimidazole. The calculated amount of bromine in this formulation is 18 wt % on a solids basis. The gel time, glass transition and decomposition temperatures of the resulting brominated resin are then measured, the results of which are presented in Table 1.

### Example 5

A commercial sample of brominated oxazolidinone resin (8.95 g of an 80% solution in acetone, D.E.R.™ 592-A80, available from The Dow Chemical Co., having an EEW of 447 g/eq) is combined with 35 mg dicyandiamide and 55 mg 2-methylimidazole. The calculated amount of bromine in this formulation is 18 wt % on a solids basis. The gel time, glass transition and decomposition temperatures of the resulting brominated resin are then measured, the results of which are presented in Table 1.

TABLE 1

| | Exam- | Exam- | Exam- | Exam- |
|---|---|---|---|---|
| | ple 1 | ple 3 | ple 4 | ple 5 |
| Oxazolidinone/Isocyanurate | 20/80 | 55/45 | 100/0 | 100/0 |
| Gel time @ 170° C., seconds | 243 | 233 | 349 | 211 |
| Tg (° C., as measured by DSC) | 161/159 | 148/149 | 150/151 | 138/137 |
| Td @ 5% weight loss | 309/312 | 309/313 | 311/313 | 314/313 |
| (° C., as measured by TGA) | | | | |

As can be seen by the results presented in Table 1, brominated resins having an oxazolidinone to isocyanurate ratio of less than 1:1, such as Example 1, have higher glass transition temperatures then the samples with a high amount of oxazolidinone. Additionally, the high glass transition temperature Example 1 also had a relatively high decomposition temperature, comparable to that of the oxazolidinone-rich Examples 3-5.

As described above, resin compositions disclosed herein may include oligomers having a molar ratio of isocyanurate to oxazolidinone greater than 1:1, wherein the weight average molecular weight of the oligomers is less than or equal to 3000, as measured by gel permeation chromatography. These resin compositions may be used to form curable compositions and thermoset compositions, such as for use in electronics encapsulation and in circuit boards. Advantageously, embodiments disclosed herein may provide for thermoset compositions, formed from the resin compositions, where the thermoset composition has both a high decomposition temperature and a high glass transition temperature. Additionally, the resin compositions may have a viscosity that minimizes at least one of voids, poor fiber wetting, and poor prepreg appearance when used as a coating, filler, etc.

In particular, it has been found that the resin compositions, as well as the curable compositions and thermoset compositions formed from the resin compositions, may advantageously be used in prepregs, laminates, and printed circuit boards in lead-free operations. Due to the high decomposition temperature and high glass transition temperature of the resulting thermoset compositions, excessive z-axis expansion of the circuit board and fracture of plated-through-copper vias may be avoided.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

1. A resin composition comprising oligomers having:
a molar ratio of isocyanurate to oxazolidinone greater than 1:1;
wherein the weight average molecular weight of the oligomers is less than or equal to 3000, as measured by gel permeation chromatography; and
wherein the oligomer comprises compounds of the general formula: 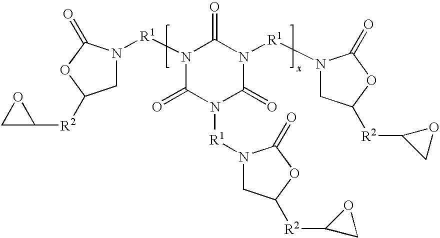
wherein x is 2.5 or greater, and R¹ and R² are independently selected from the group consisting of aromatic and aliphatic diradicals.

2. The resin composition of claim 1, wherein the ratio of isocyanurate to oxazolidinone is greater than 1.5:1.

3. The resin composition of claim 1, wherein the oligomers have a polydispersity (M_{w}/Mₙ) of less than 2.

4. (canceled)

5. The resin composition of claim 1 wherein the isocyanurate comprises trimers of diisocyanate precursors.

6. The resin composition of claim 5, wherein the isocyanate precursor comprises at least one of methane diisocyanate, butane-1,1-diisocyanate, ethane-1,2-diisocyanate, butanediisocyanate, transvinylene diisocyanate, propane-1,3-diisocyanate, 2-butene-1,4-diisocyanate, 2-methylbutane-1,4-diisocyanate, hexane-1,6-diisocyanate, octane-1,8-diisocyanate, diphenylsilanediisocyanate, benzene-1,3-bis(methyleneisocyanate), benzene-1,4-bis(methyleneisocyanate), isophoronediisocyanate, cyclohexane-1,3-bis(methyleneisocyanate), isomers of toluenediisocyanate, isomers of xylenediisocyanate, methylene bis(4-benzeneisocyanate) benzene (or MDI), bis(4-benzeneisocyanate) ether, bis(4-benzeneisocyanate) sulfide, and bis(4-benzeneisocyanate) sulfone.

7. The resin composition of claim 1, wherein the oxazolidinone comprises the reaction product of an epoxy precursor with one of an isocyanate precursor, a trimerized isocyanate precursor, and an oligomerized isocyanate precursor.

8. The resin composition of claim 1, wherein the composition has a viscosity of less than 10 poise, as measured with a cone and plate viscometer at 150° C.

9. A curable composition comprising the resin composition of claim 1 and a hardener.

10. The curable composition of claim 9, wherein the hardener comprises at least one of a dicyandiamide, an anhydride, and a phenolic curing agent.

11. The curable composition of claim 9, wherein the hardener comprises at least one of a novolac, a resole, a bisphenol, an oligomeric epoxy resins, and poly(styrene-co-maleic anhydride).

12. The curable composition of claim 9, further comprising a flame retardant selected from the group consisting of tetrabromobisphenol A (TBBA) and materials derived therefrom, reaction products of bisphenol A or TBBA with TBBA-diglycidyl ether, reaction products of bisphenol A diglycidyl ether with TBBA, materials derived from 9,10-dihydro-9-oxa-10-phosphaphenanthrene 10-oxide (DOP), condensation products of DOP with glycidyl ether derivatives of novolacs, and inorganic flame retardants.

13. (canceled)

14. The curable composition of claim 9, wherein the curable composition has a gel time at 170° C. of less than 5 minutes.

15. (canceled)

16. (canceled)

17. A process for forming a resin composition, comprising:
reacting diisocyanates to form isocyanurates;
reacting isocyanate groups in the isocyanurates and unreacted diisocyanates with an epoxy precursor to form a resin composition comprising oligomers having:
a molar ratio of isocyanurate to oxazolidinone greater than 1:1;
wherein the weight average molecular weight of the oligomers is less than or equal to 3000, as measured by gel permeation chromatography.

18. The process of claim 17, wherein at least 50 mole percent of the diisocyanates react to form isocyanurates.

19. The process of claim 17, wherein the reacting isocyanates to form isocyanurates comprises:
admixing diisocyanates at a selected feed rate with an epoxy precursor and a catalyst; and
maintaining the resulting admixture at a temperature between 100° C. and 140° C.

20. The process of claim 19, wherein the selected feed rate is continuous or intermittent, and wherein the selected feed rate maintains the concentration of isocyanate in the admixture as less than 0.5 M, expressed as moles starting NCO/L, throughout the admixing.

21. The process of claim 19, further comprising increasing the temperature of the admixture to a temperature between 140° C. and 175° C.

22. The process of claim 21, wherein the admixture is maintained at a temperature between 140° C. and 175° C. for the reacting of the isocyanate groups with an epoxy precursor.

23. The process of claim 19, wherein at least 95% of the isocyanate groups are reacted to form isocyanurates and oxazolidinones.

24. The process of claim 17, further comprising reacting monofunctional isocyanates with the diisocyanurates.

25. (canceled)
